(19) United States
(12) Patent Application Publication
(10) Pub. No.: US 2017/0046475 A1
(43) Pub. Date: Feb. 16, 2017

(54) CONFIDENCE INTERVAL ESTIMATION OF SPECIES IN METAGENOMIC DATA

(71) Applicant: International Business Machines Corporation, Armonk, NY (US)

(72) Inventors: Niina S. Haiminen, Valhalla, NY (US); Laxmi P. Parida, Mohegan Lake, NY (US); Robert J. Prill, Irvine, CA (US)

(21) Appl. No.: 14/966,410

(22) Filed: Dec. 11, 2015

Related U.S. Application Data
(63) Continuation of application No. 14/950,858, filed on Nov. 24, 2015.
(60) Provisional application No. 62/203,501, filed on Aug. 11, 2015.

(51) Int. Cl. G06F 19/12

(52) U.S. Cl. CPC G06F 19/12

(57) ABSTRACT

Embodiments are directed to a computer-based system for processing data of a sample. The system includes a memory and a processor system communicatively coupled to the memory. The processor system is configured to receive, from a sample analysis system, observed data of at least one element in the sample. The processor system is further configured to receive actual data of the at least one element, and identify error data of the observed data of the at least one element, wherein identifying the error data comprises running a simulation model that models the sample analysis system to identify properties of a relationship between the observed data of the at least one element in the sample and the actual data of the at least one element.

The present application claims priority to U.S. Non-provisional application Ser. No. 14/950,858 filed on Nov. 24, 2015, titled “CONFIDENCE INTERVAL ESTIMATION OF SPECIES IN METAGENOMIC DATA,” assigned to the assignee hereof and expressly incorporated by reference herein.

### BACKGROUND

The present disclosure relates in general to the computer-aided analysis of the constituent components of a biological sample. More specifically, the present disclosure relates to systems and methodologies for identifying errors in observed levels of an element in a sample, and for processing data of the observed levels and the identified errors to derive expected levels of the element in the sample and/or a confidence interval of the expected levels of the element in the sample.

Metagenomics is the study of genetic material recovered directly from environmental samples of a microbial community. Metagenomics involves analyzing the genomes without culturing the organisms in the community, thereby offering the opportunity to describe the planet's diverse microbial inhabitants, many of which cannot yet be cultured. Because of its ability to reveal the previously hidden diversity of microscopic life, metagenomics offers a powerful lens for viewing the microbial world that has the potential to revolutionize understanding of the entire living world. As the price of DNA sequencing continues to fall, metagenomics continue to allow microbial ecology to be investigated at a continuously greater scales and levels of detail.

In metagenomic analysis, typical systems for determining the constituent components of a sample involve three stages. The first stage is known generally as sequencing protocols, and the second stage is known generally as a bioinformatics pipeline. A sequencing protocol typically involves collecting a sample of interest, preparing the sample for analysis and generating sequence data using a DNA sequencer. Bioinformatics is an interdisciplinary field that is concerned with the acquisition, storage, and analysis of the information found in nucleic acid and protein sequence data. Bioinformatics pipelines enable life scientists to effectively analyze biological data through automated multi-step processes constructed by individual programs and databases. Scientists enter their assembled sequences into genetic databases so that other scientists may use the data. Because the sequences of the two DNA strands are complementary, it is only necessary to enter the sequence of one DNA strand into a database. By selecting an appropriate computer program, scientists can use sequence data to look for genes, get clues to gene functions, examine genetic variation, and explore evolutionary relationships.

The third stage may be referred to as ad hoc thresholding. Ad hoc thresholding takes the output of a bioinformatics pipeline, which may be a list of constituent components of a sample, along with an observed level of the constituent components in the sample, and sets a threshold for the observed level. Observed levels above the threshold are considered valid, and observed levels below the threshold are considered invalid readings. The setting of such thresholds is typically based on the skill and experience of the technician overseeing the analysis.

Errors and/or inaccuracies are inherent in metagenomic systems that determine the constituent components of a sample. Accordingly, the observed levels of constituent components generated by such systems will always include some error that is, in effect, the cumulative result of various errors in the metagenomic system. The complexities of the error sources make it challenging to employ any form of error modeling as a solution. Hence a non-parametric approach to addressing metagenomic analysis system errors is desirable. Non-parametric statistical procedures rely on no or few assumptions about the shape or parameters of the population distribution from which the sample was drawn. The ad hoc setting of thresholds is also a source of error. Additionally, because ad hoc thresholding throws out observed levels that fall below the ad hoc threshold, it is difficult for existing systems to detect the presence of constituent components in small amounts.

Accordingly, it is desirable to provide systems and methodologies that identify provide a more statistically rigorous, non-parametric determination of the expected level of a constituent component in a sample.

### SUMMARY

Embodiments are directed to a computer-based system for processing data of a sample. The system includes a memory and a processor system communicatively coupled to the memory. The processor system is configured to receive, from a sample analysis system, observed data of at least one element in the sample. The processor system is further configured to receive actual data of the at least one element, and identify error data of the observed data of the at least one element, wherein identifying the error data comprises running a simulation model that models the sample analysis system to identify properties of a relationship between the observed data of the at least one element in the sample and the actual data of the at least one element.

Embodiments are further directed to a computer implemented method of processing data of a sample. The method includes receiving observed data of at least one element in the sample from a sample analysis system. The method further includes receiving actual data of the at least one element, and identifying error data of the observed data of the at least one element, wherein identifying the error data comprises running a simulation model that models the sample analysis system to identify properties of a relationship between the observed data of the at least one element in the sample and the actual data of the at least one element.

Embodiments are further directed to a computer program product for implementing a computer-based processing of data of a sample. The computer program product includes a computer readable storage medium having program instructions embodied therewith, wherein the computer readable storage medium is not a transitory signal per se. The program instructions are readable by at least one processor system to cause the at least one processor system to perform a method. The method includes receiving, from a sample analysis system, observed data of at least one element in the sample, and receiving actual data of the at least one element. The method further includes identifying error data of the observed data of the at least one element, wherein identifying the error data comprises running a simulation model that models the sample analysis system to identify properties of a relationship between the observed data of the at least one element in the sample and the actual data of the at least one element.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features and advantages are apparent from the following detailed description taken in conjunction with the accompanying drawings in which:

FIG. 1 depicts an exemplary computer system capable of implementing one or more embodiments of the present disclosure;

FIG. 2 depicts a block diagram illustrating a system for processing data of at least one element in a sample according to one or more embodiments;

FIG. 3 depicts a flow diagram illustrating a methodology according to one or more embodiments;

FIG. 4 depicts a flow diagram illustrating another methodology according to one or more embodiments;

FIG. 5 depicts a diagram illustrating an exemplary configuration of a joint distribution according to one or more embodiments;

FIG. 6 depicts equations for determining an expected level of an element of interest in a sample, and for determining a confidence interval of the expected level, according to one or more embodiments;

FIG. 7 depicts tables illustrating read results obtained from an experimental implementation according to one or more embodiments;

FIG. 8 depicts a table illustrating actual fractions utilized in an experimental implementation according to one or more embodiments; and

FIG. 9 depicts a computer program product in accordance with one or more embodiments.

In the accompanying figures and following detailed description of the disclosed embodiments, the various elements illustrated in the figures are provided with three or four digit reference numbers. The leftmost digit(s) of each reference number corresponds to the figure in which its element is first illustrated.

### DETAILED DESCRIPTION

Various embodiments of the present disclosure will now be described with reference to the related drawings. Alternate embodiments may be devised without departing from the scope of this disclosure. It is noted that various connections are set forth between elements in the following description and in the drawings. These connections, unless specified otherwise, may be direct or indirect, and the present disclosure is not intended to be limiting in this respect. Accordingly, a coupling of entities may refer to either a direct or an indirect connection.

Turning now to an overview of the present disclosure, one or more embodiments provide systems and methodologies for identifying errors in observed levels of an element in a sample, and for processing data of the observed levels and the identified errors to derive expected levels of the element in the sample and/or a confidence interval of the expected levels of the element in the sample.

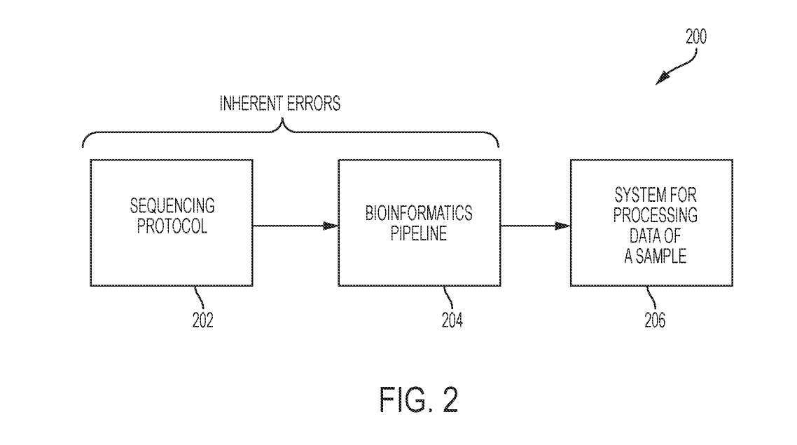

Any sampling process (e.g., a sequencing protocol shown in FIG. 2), coupled with a software pipeline (e.g., a bioinformatics pipeline shown in FIG. 2) will introduce errors. The present disclosure quantifies this error so that the task of detecting the existence of a species is not confounded by the error. The present disclosure also provides the ability to detect trace elements (i.e., very small proportions) with high confidence, and to provide a more statistically rigorous way to identify trace elements that are likely to be phantom due to errors in the sample preparation and/or software errors. If U denotes the universal set of species, given some metagenomic sample of unknown composition drawn from U as S={Aᵢ|AᵢεU}, the task performed by the present disclosure is to estimate an interval containing the actual proportion of each Aᵢ (i.e., each species present in the sample) with high confidence (e.g., 95%).

The present disclosure consolidates the errors from sample preparation to the software pipeline that maps the reads to species. For each species AᵢεU, a joint distribution Fᵢ(fₐ, fₒ) is estimated, wherein where fₐ is the actual fraction of species Aᵢ in the sample, and fₒ is the observed fraction of the unique read counts, or some other measure, resulting from the software pipeline. Under ideal conditions with no inherent error, the actual fraction and the observed fraction of a given species are completely equal. However, because of the inherent errors in sample analysis methodologies (e.g., sequencing protocols, bioinformatics pipelines and ad hoc thresholding), the observed fraction fₒ is some distorted view of the actual fraction fₐ. To address this distortion, the present disclosure creates a model that relates the observed fractions with what are estimated to be the true actual fraction.

The present disclosure creates models using computer simulation, which is referred to herein as creating a joint distribution. The joint distribution is a distribution of the actual fractions vs. observed fractions for the particular sequencing protocol and bioinformatics pipeline under consideration. Computer-based simulation tools are used to understand the evolutionary and genetic consequences of complex processes. Computer-based simulation tools often involve a range of components, including modules for preparation, extraction and conversion of data, program codes that perform experiment-related computations, and scripts that join the other components and make them work as a coherent system that is capable of displaying desired behavior. Although these tools have traditionally been used in population genetics by a fairly small community with programming expertise, the rapid increase in computer processing power in the past few decades has enabled the emergence of sophisticated, customizable software packages for performing experiments in silico (i.e., on a computer or via computer simulation), whereby research is conducted with computer simulated models that closely reflect the real world.

For example, taking a sample that is composed of a collection of 10 species, the inquiry may be to make a determination of the fraction of each species in the sample. A measurement is done to obtain observed fractions. Because of noise in the process of decoding information, the observed fractions have corresponding actual fractions that at this point are unknown. To understand the statistical properties of the relationship between the observed fraction and the actual fraction, the present disclosure uses computer simulations to create a model of the relevant sample analysis system. If the relationship between the observed fractions and the actual fractions is represented by a function F, the model in the computer is a model of the relationship between fₐ and fₒ actually is. Thus, a function F may be created for each individual species in the sample.

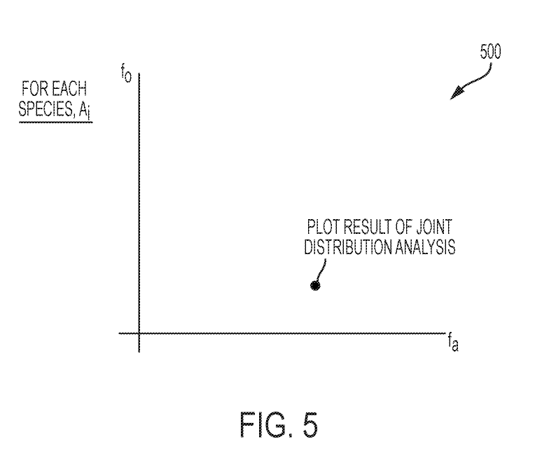

The joint distribution for a given species in a sample may be represented as a table having spreadsheet format, and example of which is shown at 500 in FIG. 5. Accordingly, for each species, Aᵢ, a joint distribution may be created in the form of a spreadsheet, wherein the spreadsheet rows are the actual fractions and the spreadsheet columns are the observed fractions. The computer simulation is run to simulate data sets to which the answer is known, and then the results of these simulations are analyzed. The spreadsheet cells are filled in by running the simulations many times and plotting the simulated fₐ against the fₒ output from the sample analysis system (e.g., sequencing protocols and bioinformatics pipeline).

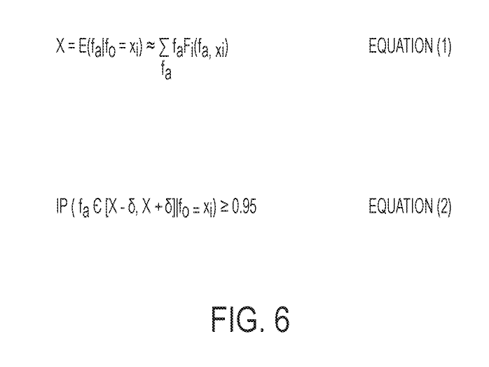

The completed joint distribution identifies and sets up the statistical relationship between fₐ and fₒ for a given species such that an expected actual fraction of the species in the sample may now be determined by application of Equation (1) shown in FIG. 6, and the desired confidence interval (e.g., ≧95%) may also be determined by application of Equation (2) shown in FIG. 6.

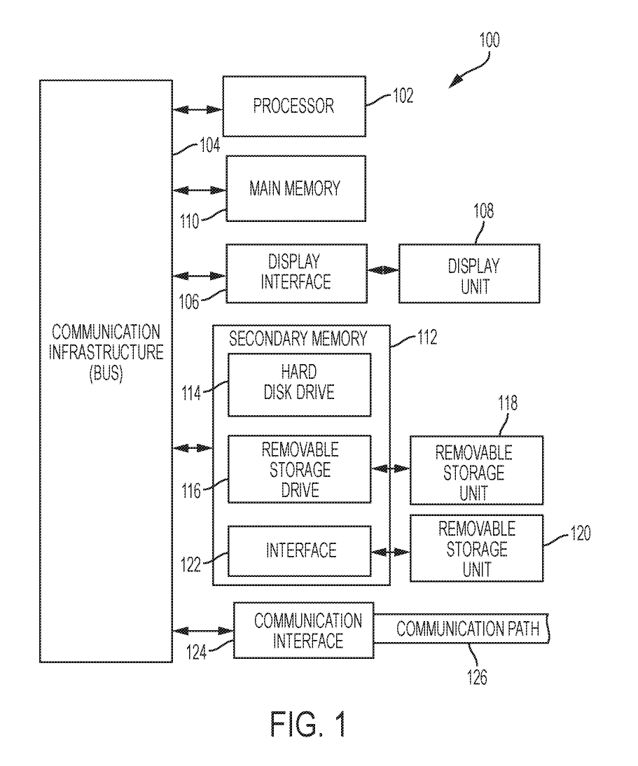

Turning now to a more detailed description of the present disclosure, FIG. 1 illustrates a high level block diagram showing an example of a computer-based simulation system 100 useful for implementing one or more embodiments. Although one exemplary computer system 100 is shown, computer system 100 includes a communication path 126, which connects computer system 100 to additional systems and may include one or more wide area networks (WANs) and/or local area networks (LANs) such as the internet, intranet(s), and/or wireless communication network(s). Computer system 100 and additional system are in communication via communication path 126, e.g., to communicate data between them.

Computer system 100 includes one or more processors, such as processor 102. Processor 102 is connected to a communication infrastructure 104 (e.g., a communications bus, cross-over bar, or network). Computer system 100 can include a display interface 106 that forwards graphics, text, and other data from communication infrastructure 104 (or from a frame buffer not shown) for display on a display unit 108. Computer system 100 also includes a main memory 110, preferably random access memory (RAM), and may also include a secondary memory 112. Secondary memory 112 may include, for example, a hard disk drive 114 and/or a removable storage drive 116, representing, for example, a floppy disk drive, a magnetic tape drive, or an optical disk drive. Removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc. which is read by and written to by removable storage drive 116. As will be appreciated, removable storage unit 118 includes a computer readable medium having stored therein computer software and/or data.

In alternative embodiments, secondary memory 112 may include other similar means for allowing computer programs or other instructions to be loaded into the computer system. Such means may include, for example, a removable storage unit 120 and an interface 122. Examples of such means may include a program package and package interface (such as that found in video game devices), a removable memory chip (such as an EPROM, or PROM) and associated socket, and other removable storage units 120 and interfaces 122 which allow software and data to be transferred from the removable storage unit 120 to computer system 100.

Computer system 100 may also include a communications interface 124. Communications interface 124 allows software and data to be transferred between the computer system and external devices. Examples of communications interface 124 may include a modem, a network interface (such as an Ethernet card), a communications port, or a PCM-CIA slot and card, etcetera. Software and data transferred via communications interface 124 are in the form of signals which may be, for example, electronic, electromagnetic, optical, or other signals capable of being received by communications interface 124. These signals are provided to communications interface 124 via communication path (i.e., channel) 126. Communication path 126 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 110 and secondary memory 112, removable storage drive 116, and a hard disk installed in hard disk drive 114. Computer programs (also called computer control logic) are stored in main memory 110 and/or secondary memory 112. Computer programs may also be received via communications interface 124. Such computer programs, when run, enable the computer system to perform the features of the present disclosure as discussed herein. In particular, the computer programs, when run, enable processor 102 to perform the features of the computer system. Accordingly, such computer programs represent controllers of the computer system.

FIG. 2 depicts a block diagram illustrating a system 200 for processing data of at least one element in a sample according to one or more embodiments. As shown, system 200 includes a sequencing protocol 202, a bioinformatics pipeline 204 and a system for processing data of a sample 206, configured and arranged as shown. Sequencing protocol 202 may be implemented as any system for collecting a sample of interest, preparing the sample for analysis and generating sequence data using, for example, a DNA sequencer. Bioinformatics is an interdisciplinary field that is concerned with the acquisition, storage, and analysis of the information found in nucleic acid and protein sequence data. Bioinformatics pipelines 204 may be implemented as any system that enables life scientists to analyze biological data through automated multi-step processes constructed by individual programs and databases.

Errors and/or inaccuracies are inherent in sequencing protocol 202 and bioinformatics pipeline 204. Accordingly, the observed levels of constituent components generated by sequencing protocol 202 and bioinformatics pipeline 204 will always include some error that is, in effect, the cumulative result of various errors in sequencing protocol 202 and bioinformatics pipeline 204. The complexities of the error sources make it challenging to employ any form of error modeling as a solution. Hence a non-parametric approach to addressing errors is desirable. Non-parametric statistical procedures rely on no or few assumptions about the shape or parameters of the population distribution from which the sample was drawn.

System for processing data of a sample (i.e., sample processing system) 206 provides the systems and methodologies for identifying errors in observed levels of an element in a sample generated by sequencing protocol 202 and bioinformatics pipeline 204. Sample processing system 206 processing data of the observed levels and the identified errors to derive expected levels of the element in the sample and/or a confidence interval of the expected levels of the element in the sample, in accordance with one or more embodiments of the present disclosure, sequencing protocol 202 and bioinformatics pipeline 204

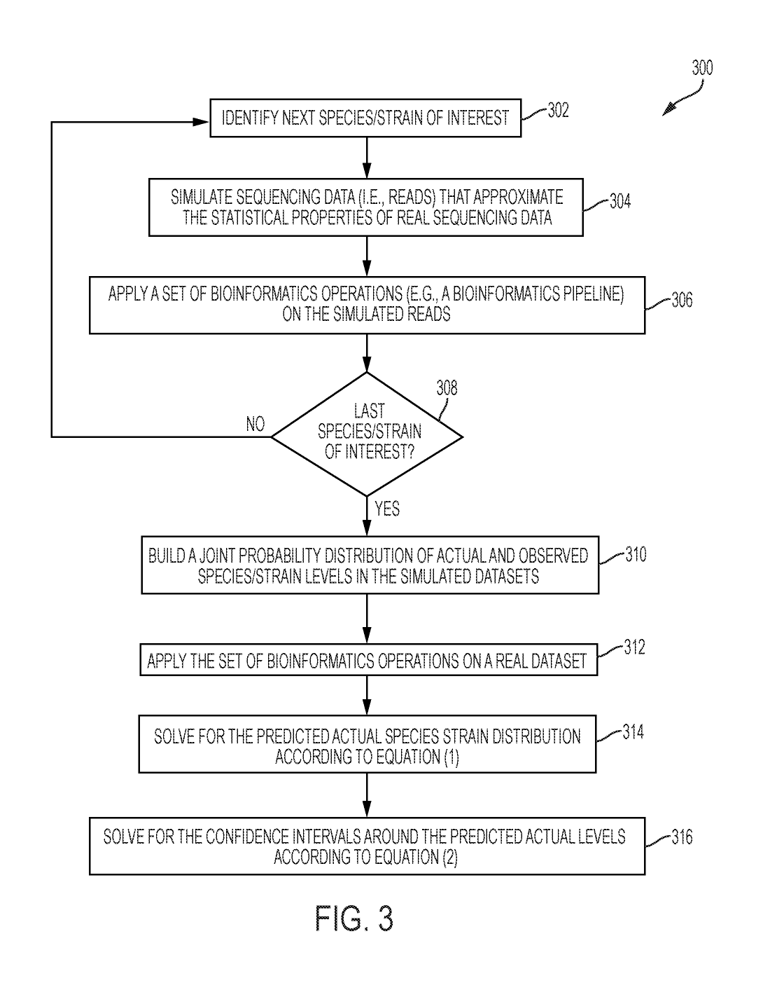

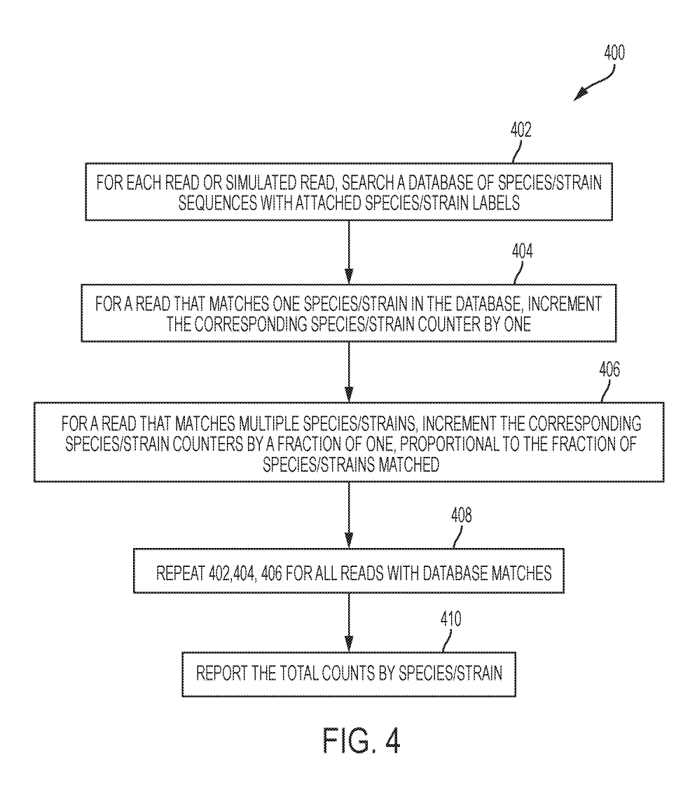

The operation of system 200, and particularly sample processing system 206, will now be described with reference to a methodology 300 and a methodology 400 shown in FIGS. 3 and 4, respectively. Methodology 300 begins at block 302 by identifying a next species/strain of interest. Block 304 simulates sequencing data (i.e., reads) that approximate the statistical properties of real sequencing data. For example, the simulated sequencing data and the real sequencing data may have the same read length. Block 304 may be accomplished by sampling sequences from a genome sequence, such as the genome sequence of species/strain salmonella enterica subsp. enterica serovar typhimurium str. LT2. Block 304 requires many data points, or may require repeating blocks 302-308 many times to build block 310. Block 306 applies a set of bioinformatics operations (i.e., the relevant bioinformatics pipeline 204 shown in FIG. 2) on the simulated reads to infer the species/strain composition of the simulated dataset. The actual species/strain distribution is completely known from the simulation. The observed species/strain distribution is the output of the bioinformatics pipeline. The species/strain identification may be implemented according to methodology 400 shown in FIG. 4 and described in more detail herein below.

Decision block 308 determines whether the last species/strain of interest has been identified. If the answer to the inquiry at block 308 is no, methodology 300 returns to block 302 and identifies the next species/strain of interest. If the answer to the inquiry at block 308 is yes, methodology 300 proceeds to block 310 and builds a joint probability distribution of actual and observed species/strain levels in the simulated datasets, and example of which is shown by the spreadsheet format joint distribution 500 shown in FIG. 5. Block 312 applies the set of bioinformatics operations on a real dataset using the same set of bioinformatics operations as in block 306 on a real dataset composed of sequencing reads from a mixture of species/strains present in unknown proportions. The observed species/strain distribution is the output of bioinformatics pipeline 204. The actual species/strain/strain distribution is unknown.

Block 314 solves for the predicted actual species strain distribution according to Equation (1) shown in FIG. 6. Block 316 solves for the confidence intervals around the predicted actual levels according to Equation (2) shown in FIG. 6. The confidence intervals are estimated from empirical joint distribution 500 (shown in FIG. 5) of actual and observed species/strain levels.

As noted above, the species/strain identification may be implemented according to methodology 400 shown in FIG. 4, which will now be described. Methodology 400 begins at block 402 by, for each read or simulated read, searching a database of species/strain sequences with attached species/strain labels. Block 404, for a read that matches one species/strain in the database, increments the corresponding species/strain counter by one. Block 406, for a read that matches multiple species/strains, increments the corresponding species/strain counters by a fraction of one, proportional to the fraction of species/strains matched. Block 408 repeats block s 402, 404 and 406 for all reads with database matches. Block 410 reports the total counts by species/strain.

To further illustrate the present disclosure, an example implementation according to one or more embodiments will now be provided. In the example implementation, simulated reads were generated from the salmonella enterica subspecies, whole genomes of serovar typhimurium str. LT2 (causes gastroenteritis and food poisoning) and serovar typhi str. CT18 (causes typhoid fever). The assignment of sequencing reads to the correct genome following the simulated sequencing and bioinformatics steps included source of confusion and ad hoc processes, including for example, reads that match multiple species, related absent species showing up on the top of the list of matching species, and only a few uniquely mapping reads are observed.

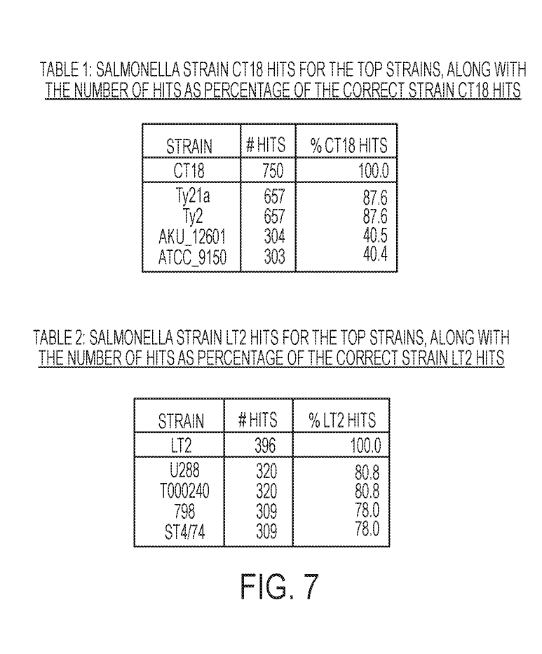

The example implementation proceeded according to the following operations: (1) simulate 10,000 reads from the genome sequences of two salmonella enterica strains (e.g., including sampling and sequencing biases and errors); (2) match each read to a database of known genome sequences (e.g., using local alignment tool against database of 40 known salmonella sequences); (3) keep reads with, for example, ≧97% sequence identity and, for example, ≧97% coverage of the read; (4) count the number of hits per species—for reads with multiple hits, count fractional hits (e.g., 2 hits each receive a count of 0.5); and (5) report the total number of reads supporting a strain, species or genus-level prediction (e.g., salmonella strain). The results in Table 1 and Table 2, shown in FIG. 7, list the number of read matches for the two salmonella strains. In both cases, the correct strain receives the most matches. However, the second most frequent and incorrect strain receives up to 87.6% of the number of hits for the top strain. Such discrepancies or confusion can mislead a purely ad hoc threshold based method, but the joint distribution of the present disclosure handles such discrepancies effectively.

To further illustrate the present disclosure, another example implementation according to one or more embodiments will now be provided. The example describes an end-to-end procedure that included the simulation and analysis of a dataset for which the actual fraction (fₐ) of all species/strains is known. The example includes three parts, namely, simulating the joint distribution F, running a bioinformatics pipeline that produces fₒ, and the decoding of fₒ into the expected value and confidence interval of fₐ.

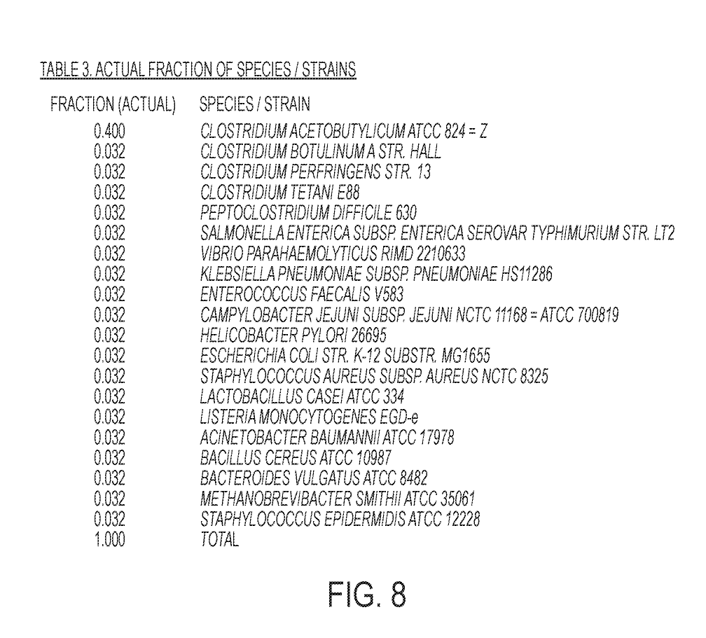

The joint distribution F was generated according to the following operations: (1) define a mixture of 20 bacterial species with actual fractions (fₐ) given in Table 3 shown in FIG. 8; (2) select one species/strain, clostridium acetobutylicum, as a species of interest and call it species Z; (3) simulate 10,000 DNA sequencing “reads” from 16S rRNA genes using, for example, wgsim software (uniform sequencing errors at 0.05%) to produce fₐ for the universe of species defined by the GreenGenes database; (4) with fₐ(Z) ranging from 0 to 0.99 in intervals of 0.005 (and other species/strains adjusted to total 1) repeat operation 3, thus generating a very large number of scenarios; (5) for each simulated instance of simulated DNA sequencing reads, run “bioinformatics pipeline” according to the methodology described below to obtain the fraction observed (fₒ) for all species in the universe of species; and (6) compute F(Z), which is the joint distribution of Z in variables fₐ and fₒ.

The bioinformatics pipeline takes as inputs the DNA sequencing reads and returns as outputs the observed fraction (fₒ) of every species/strain in the universe (e.g., in the GreenGenes database). Any procedure that accomplishes the above-described input-output mapping is a valid bioinformatics pipeline. One non-limiting example of a suitable the bioinformatics pipeline to produce species observed fractions fₒ proceeds according to the following operations: (1) for each DNA sequencing read, search GreenGenes 16S rRNA database using MegaBLAST, which is a computer program for nucleotide sequence alignment search optimized for aligning sequences that differ slightly as a result of sequencing or other similar errors; (2) accept database search hits with 97% identity and 97% query sequence coverage; (3) for each read with a MegaBLAST hit, if all hits to same “taxon k,” increment “taxon k” counter by 1, and if multiple hits to n distinct “taxa,” increment counters of member “taxa” by 1/n; (4) repeat operations 1-3 until all reads have been analyzed; and (5) obtain fraction fₒ, which is the fraction of total reads assigned to species Z.

The decoding of fₒ into expected value and confidence interval for fₐ proceeds according to the following operations. In accordance with the parameters given in Table 3 of FIG. 8, one additional instance of DNA sequencing reads is simulated. This dataset may be used as a stand-in for a real dataset. Applying the bioinformatics pipeline, fₒ(Z)=0.33 is obtained, for example. This value is converted to an expected value and confidence interval for fₐ(Z), which is the actual fraction of species Z (Clostridium acetobutylicum). Applying Equations (1) and (2) (shown in FIG. 6) to the joint distribution F, an expected value of 0.399 and a 95% confidence interval [0.39, 0.41] for fₐ(Z) is computed in this example.

Accordingly, it can be seen from the foregoing specification and drawings that the present disclosure provides systems and methodologies for identifying errors in observed levels of an element in a sample, and for processing data of the observed levels and the identified errors to derive expected levels of the element in the sample and/or a confidence interval of the expected levels of the element in the sample. The disclosed systems and methodologies can be applied to detect, within a confidence interval, pathogenic strains of a species or genus, e.g. Salmonella. The disclosed systems and methodologies can also be applied, for example, to providing alerts of contamination in food samples. The disclosed systems and methodologies can be applied to detect the presence of any species in the sample, which is useful, for example, in determining the composition of human or animal gut microbiome in order to provide a diagnosis and suggest treatments. The disclosed systems and methodologies may also be used for confirming ingredients or detecting fraud in organic samples, such as organic food samples.

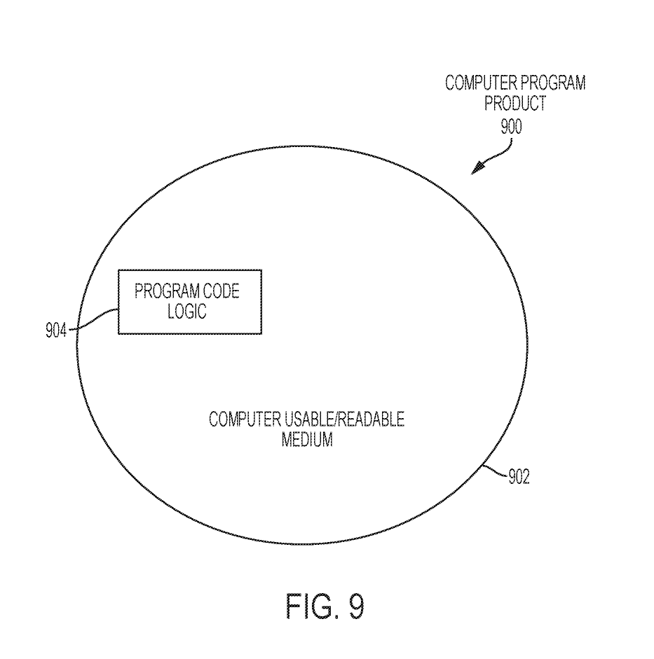

Referring now to FIG. 9, a computer program product 900 in accordance with an embodiment that includes a computer readable storage medium 902 and program instructions 904 is generally shown.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It will be understood that those skilled in the art, both now and in the future, may make various improvements and enhancements which fall within the scope of the claims which follow.

What is claimed is:

1. A computer implemented method of processing data of a sample, the method comprising:
receiving, by a processor system, observed data of at least one element in the sample from a sample analysis system;
receiving, by the processor system, actual data of the at least one element; and
identifying, using the processor system, error data of the observed data of the at least one element;
wherein identifying the error data comprises running a simulation model that models the sample analysis system to identify properties of a relationship between the observed data of the at least one element in the sample and the actual data of the at least one element.

2. The method of claim 1, wherein identifying the properties of the relationship between the observed data of the at least one element of the sample and the actual data of the at least one element comprises:
using the simulation model to generate a joint distribution comprising a plot of the relationship between the observed data of the at least one element in the sample and the actual data of the at least one element.

3. The method of claim 2, wherein the generation of the joint distribution comprises running multiple iterations of the simulation model.

4. The method of claim 1 further comprising:
determining, using the processor system, an expected level of the at least one element in the sample based at least in part on the identified error data.

5. The method of claim 4 further comprising:
determining, using the processor system, a confidence interval of the expected level of the at least one element in the sample based at least in part on the identified error data.

6. The method of claim 5 wherein the expected level of the at least one element in the sample comprises a fraction of the sample.

7. The method of claim 5, wherein the sample analysis system comprises:
a sequencing protocol; and
a bioinformatics pipeline.
